(19) United States
(12) Patent Application Publication
(10) Pub. No.: US 2008/0091497 A1
(43) Pub. Date: Apr. 17, 2008

(54) Broadcast Days

(76) Inventors: Patrick Julien, Mascouche (CA); Bryan Mongeau, Montreal (CA); Daniel Parisien, Montreal (CA)

Correspondence Address: TECHNOLOGY LAW GROUP, LLC, 8950 W. EMERALD STREET STE. 198, BOISE, ID, 83704, US

(21) Appl. No.: 11/828,110

(22) Filed: Jul. 25, 2007

Related U.S. Application Data
(60) Provisional application No. 60/820,589, filed on Jul. 27, 2006.
(60) Provisional application No. 60/820,591, filed on Jul. 27, 2006.
(60) Provisional application No. 60/820,594, filed on Jul. 27, 2006.
(60) Provisional application No. 60/820,595, filed on Jul. 27, 2006.
(60) Provisional application No. 60/820,598, filed on Jul. 27, 2006.

(51) Int. Cl. G06Q 30/00; G06Q 10/00; H04N 5/202

(52) U.S. Cl. 705/8; 348/674; 705/14; 348/E05.074

(57) ABSTRACT

A system and method for efficiently managing advertising content on a network of electronic displays utilizing a broadcast day rule set identifies suitable conditions for the display of electronic messages at each display locations. Alternate embodiments provide for managed frame layouts, a loop policy to managing repeating content, weighting parameters, blocking schedules, dwell time parameters and device controls.

### CROSS-REFERENCE TO RELATED APPLICATIONS

This application claims priority under 35 U.S.C. §119(e) to U.S. Provisional Application No. 60/820,589, filed Jul. 27, 2006, entitled “Network Control Time Spans,” U.S. Provisional Application No. 60/820,591, filed Jul. 27, 2006, entitled “Broadcast Day,” U.S. Provisional Application No. 60/820,594, filed Jul. 27, 2006, entitled “Campaign Performance Report,” U.S. Provisional Application No. 60/820,595, filed Jul. 27, 2006, entitled “Day Part Frame Criteria,” and U.S. Provisional Application No. 60/820,598, filed Jul. 27, 2006, entitled “Fine-Grained Criteria Targeting”, the entire contents of each are hereby incorporated by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to enhancements to digital signage system. More particularly, the invention relates to a system and method of a more efficient system of automating and managing the administration of a network of digital signs.

Consumer product advertising is rapidly migrating from traditional media, such as billboards, newspapers, magazines, mailings, television and radio, to a medium of networks of digital signs. A digital sign network typically includes a number of display units, where each display unit typically is divided into multiple frames, and each frame is able to display an advertising message. The digital paradigm is vastly superior to traditional signage systems because content can be changed instantly and inexpensively, allowing a single display unit to service multiple advertisers. This is often a “win-win” situation for both consumers and advertisers. Consumers generally find changing content more interesting. The digital paradigm benefits advertisers who can “time share” valuable advertising space and venues with other advertisers, giving them more affordable access to formally cost prohibitive advertising platforms.

Advertising customer typically purchase campaigns. In a typical campaign, the customer provides the ad content and specifies generally the display types, locations, times, and frequency to display certain ad content. The digital signage system then has to determine a schedule involving multiple advertising campaigns from different advertisers with the available display units in the system. The scheduling is relatively simple with small networks, but becomes exponentially more difficult as either the number of advertisers or the number of display units increase assignments reliable, efficiently, and in a timely manner.

FIG. 1 depicts generally a typical prior art system. Referring to FIG. 1, such a system typically includes several electric displays 10, each typically having a large screen capable of displaying one or more advertisings messages. Frequently, the visual area of the electronic displays is subdivided into multiple display frames 20, each frame capable of separate advertising message. For example, a display 20 might be divided into several tile frames 20 or perhaps include a ticker frame 20 across the top or bottom. FIG. 1 also depicts a scheduler 40 and a campaign schedule 50. The individual campaign schedule 50 typically represents the requirements of a particular advertiser, consisting of one or more advertisements, or scheduled display events 60 to be displayed, and some general parameters regarding the frequency and location.

The scheduler 40 of FIG. 1 manages typically several campaign schedules 50 and actually determines which messages go to which frames, and the timing and frequency of such messages. For example, a campaign schedule 50 might include a requirement to display a particular advertising message 100 times a day within 5 Wal-Marts of a large metropolitan area for a particular month. The scheduler 40 would typically choose the particular Wal-Marts, the particular frames, and the exact time for the messages.

Typically, the scheduler 40 is not totally automatic and often includes interaction from a human manager. First of all, before a campaign schedule 50 can be determined, it is often helpful, if not absolutely required, to query the system generally to determine how much messaging capacity is available and the nature of the availability, since the typical system is managing both large numbers of campaign schedules 50 and frames 20 at the same time.

In prior art systems the scheduler 40 typically has access to campaign schedules 50 and the frames 20 of a network, and then has to make a mapping that both satisfies customer requirements as reflected in the collective campaign schedules 50, and the network of electronic displays 10 and the associated display frames 20. This mapping is not particularly difficult if the number of campaign schedules 50 and the number of electronic displays 10 in the network are relatively low.

In modern digital signage systems, the networks are often very large, including hundreds or even thousands of campaign schedules and a diverse collection of electronic displays in many different locations, different geographies, different time zones, and different types of businesses. In such a large network, efficient mapping, although still theoretically possible, is very difficult because it requires the scheduler 40 (or the person operating the scheduler 40) to take into account the significant differences of the placement, time, and geographical location of the various electronic displays 10.

FIG. 2 illustrates generally one way digital signage systems are implemented in the prior art using a public broadband system such as the internet. FIG. 2 depicts display frames 20 encapsulated in electronic displays 10 of FIG. 1. FIG. 2 illustrates a content server 100 which generally is a computer that physically delivers content to the electronic displays 10. In the system of FIG. 2, the content is stored in a central persistent server 130 and then is delivered to the content servers 100 over the internet 150. FIG. 2 also illustrates an optional edge server 110 primarily as an aid in content distribution. Advertising campaigns often require duplicate content for a number of servers in the same locale. In such a situation, broadband networking bandwidth can be conserved when the necessary advertising content for a locale can be serviced by a more local edge server 110 that downloads content from a remote server exactly once, and then the edge server 110 acts as a local repository for content and can use a more local network to deliver content to the associated contents servers 100. Edge servers 110, as well as content servers 100 can optionally store mirrors of advertising content required by the local content servers 100 so that if the link 160 between the content servers 100 and the internet 150 (or a local edge server 110) is broken for whatever reason, the system can still function using mirrored content. In FIG. 2, the edge server 110 and the content server 100 are shown as distinct elements but in some implementations the edge server 110 and the content server 100 are housed in a single computer. FIG. 2 also depicts a scheduling function 40 that is part of a larger administrative portal 120. The administrative portal 120 allows the system to be managed from the internet 150.

The prior art systems of FIG. 1 and FIG. 2 work well with small networks and few advertisers. However, when the network of displays is large, covers multiple time zones, includes a mixture of indoor and outdoor displays, includes displays in retail outlets in different time zones and varied operating hours, efficient network management is very difficult. Traffic patterns can vary widely at different times of day. Under such situations, the schedule generally has to logically divide the campaigns into a large number of smaller sub-campaigns where each sub-campaign targets a particular display at a particular time. This is generally a time consuming, inefficient, and error-prone task, since the scheduler must take into account all of the display units and their various operating schedules.

When an advertiser places an order, the administrator needs to query the network to locate displays that are both suitable and available to fulfill the campaign requirements. If the campaign requirements include diverse requirements—which is generally the case—the administrator will often need to subdivide the campaign into smaller, simpler campaigns, each subcampaign directed at a particular locale or a particular type of display, or perhaps a group of displays that share common characteristics such as identical operating hours. For example, a campaign that is to run seven days a week can use displays that have traffic only during business hours Monday to Friday, but then will have to target different displays for the weekends and evenings. A campaign that requires a mixture of both outdoor advertising and indoor advertising will generally require a sub-campaign for each type. Retail locations frequently have limited and varied operating hours making it non-trial to both map campaigns to appropriate displays at appropriate times, and make efficient use of the bandwidth of each display to maximize revenue opportunity for the advertising service provider. What is needed is a more advanced system that can reduce the complexity of managing a large digital signage network, and efficiently map advertising campaigns to displays such that campaign requirements are met and the resource are used efficiently without overburdening the administrator.

### BRIEF SUMMARY OF THE INVENTION

The present invention solves the problems addressed above and provides additional new and unobvious benefits over the prior art. The present invention provides associating a unique “broadcast day” rule set, independent from any particular advertising campaign, with either each individual electronic display unit, or with each display frames in a network of electronic displays. The frame paradigm provides that an electronic display can be partitioned into two or more display frames, thus allowing multiple messages to be displayed on a single electronic display. A broadcast day rule set typically has an interval associated with it that identifies the time period that the rule set is operational. Multiple broadcast day rule sets, sometimes called day parts, can be assigned to the same frame at different times, thus providing for alternate rules sets that become active at different times, allowing the system to adjust for traffic patterns that predictably change over time. Each day part rule set operates for a specified time period, and contains a loop policy and frame layout for the specific time period at the specific location.

The frame layout describes how a particular electronic display is partitioned into frames, where each frame is capable of displaying an independent advertisement, so that multiple advertising messages can appear on the same electronic display simultaneously when appropriate. The loop policy controls how often it is appropriate to repeat content. A weighting parameter may also be associated with a broadcast day rule set. The weighting parameter is used to resolve conflicts if there are competing rules sets for the same frame or display that overlap in time. Typically, a rule set having a greater weighting parameter will override a rule set covering the same time period having a lesser weighting parameter.

Encapsulating these valuable parameters into a display unit specific broadcast day rule set allows the system to intelligently and automatically allocate multiple large advertising campaigns to specific units within the signage network, respecting the parameters of the advertising campaign, the operating hours of the establishment hosting the display unit, and expected variations in traffic patterns.

Although similar results can be achieved in prior art systems, such results require significantly more scheduling resources, and furthermore, require the schedule to have detailed knowledge of the operating schedules of the various venues and then to use this knowledge and expertise to make efficient allocation decisions. In systems practicing the present invention, the system, not the administrator, uses the system knowledge encapsulated in the “broadcast day” rule sets to make optimal allocation decisions accurately and quickly, adjusting for frequently changing traffic patterns. When broadcast day rule sets are added to a system, it eliminates the complexities that would be required by a scheduler to meet the operating schedules of various displays throughout the system. Under this new system, content is schedule based on the requirements of the advertising campaign; details of display and locations nuances are largely hidden and managed transparently by the system. Using the present invention, scheduling complexity is drastically reduced for venues that have widely varying audience demographics and traffic patterns that vary over time.

### BRIEF DESCRIPTION OF THE SEVERAL VIEWS OF THE DRAWINGS

FIG. 1 is a block diagram showing generally the basic components of a prior art digital signage system.

FIG. 2 is a block diagram showing generally a typical prior art digital signage system as implemented using an internet.

FIG. 3 depicts generally the broadcast day rule set of the present invention.

FIG. 4 depicts generally the embodiment broadcast day rule set of the present invention utilizing multiple day part rules sets.

### DETAILED DESCRIPTION OF THE INVENTION

The present invention significantly advances the prior art by introducing the unique broadcast day rule set. A broadcast day rule set is associated with each electronic display 10, and encapsulates useful knowledge about the display, its configuration, capabilities, and anticipated traffic patterns. Generally a broadcast day rule set encapsulates three major concepts in a synergistic way: (1) operating hours, (2) display geometries and capabilities, and (3) anticipated audience characteristics, and then associates them with an electronic display, providing significant benefits not found in prior art systems. Operating hours influences when advertising messages can be displayed, display geometries and capabilities influences how and what advertising messages can be displayed and audience characteristics influences both how and when particular advertising messages should be displayed.

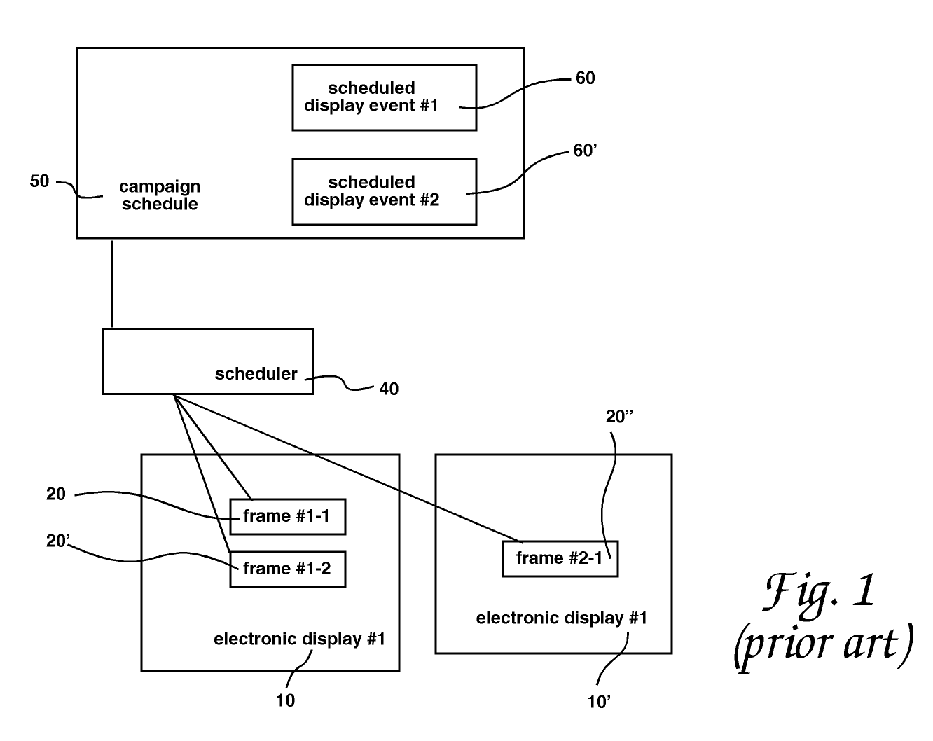

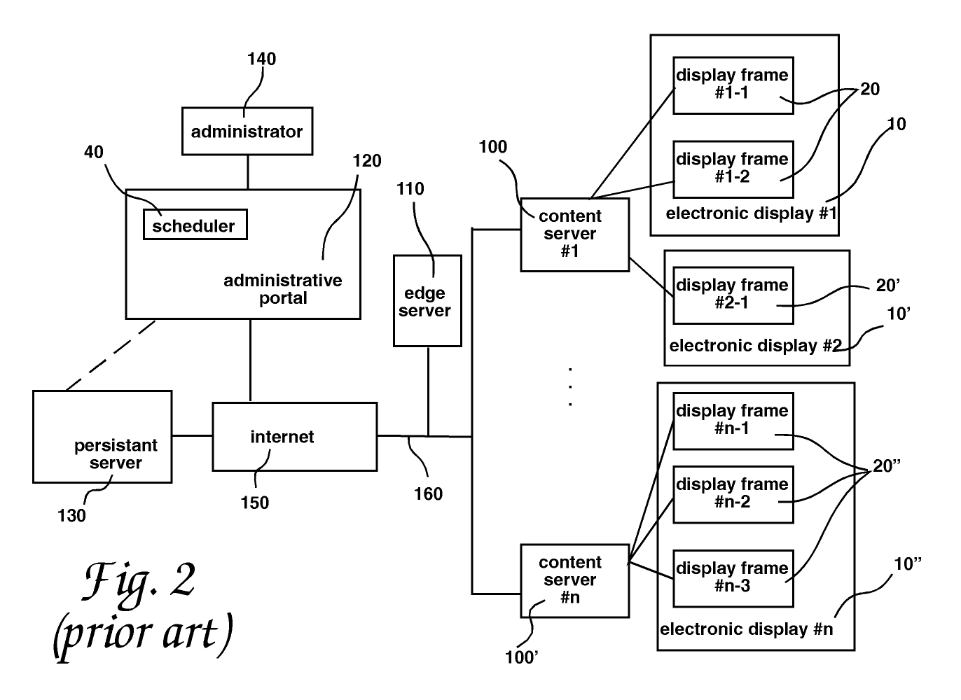

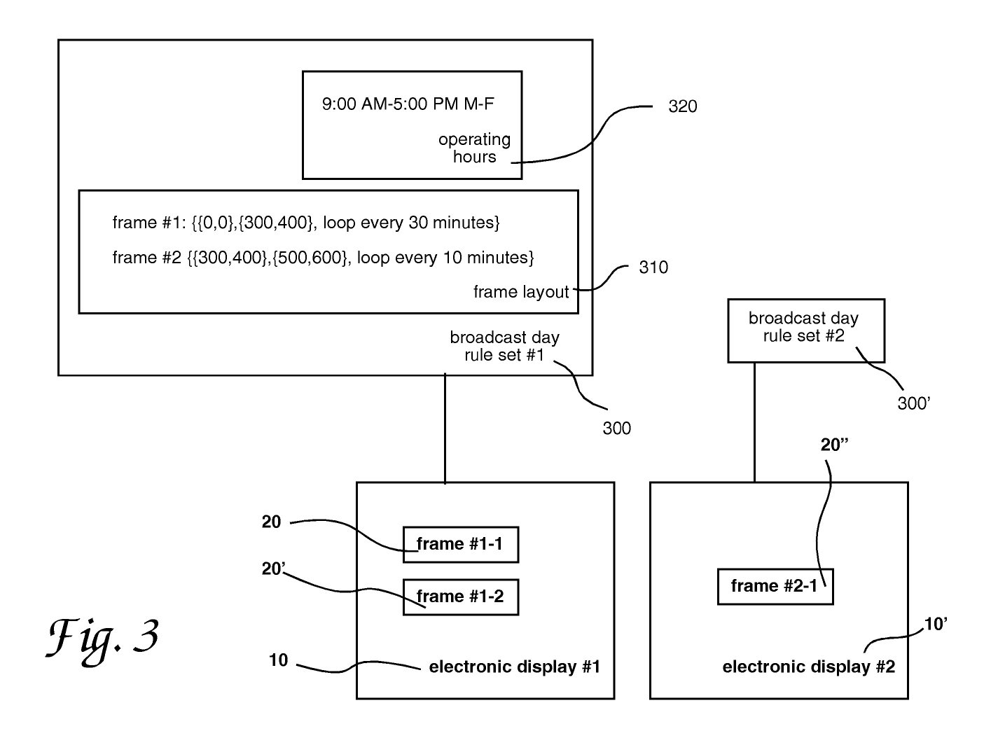

FIG. 3 depicts generally the present invention. In the present invention, a broadcast day rule set is introduced. A broadcast day rule set is defined for each electronic display in the system and contains all the rules for displaying advertising content on the electronic display in its intended location, irrespective of the details of any particular campaign. Generally, the broadcast day rule set would include any rules about the location of the associated display unit, its display properties and capabilities, and rules relating to the anticipated traffic pattern for the display unit. Thus, when the system of the present invention is presented with one or more advertising campaigns, the system analyzes the campaign requirements against the broadcast day rule set to determine specific times and frames of each display unit that would be appropriate to fulfill the requirements of the advertising campaign. In a query mode, the system can return availability information and candidate schedules, which can then be used by the schedule to make specific assignment. Referring to FIG. 3, the system of FIG. 3 includes a network of electronic displays 10, each display having one or more logical frames 20, as in the prior art system of FIG. 1 and FIG. 2. FIG. 3 also show generally a broadcast day rule set 300 associated with each electronic display 10. The broadcast day rule set encapsulates all the rules and knowledge of the particular electronic display 10 at its anticipated location.

The term “broadcast day rule set” is defined herein to be any set of rules associated with an electronic display in a particular location that identifies appropriate conditions that, if met, will allow a particular advertising message to be displayed.

In the embodiment of FIG. 3, the broadcast day rule set includes operating hours 320, frame layout information 310, and loop policies. In the embodiment of FIG. 3, the loop policies are shown as part of the frame layout 310, but could also be implemented as separate rules within the broadcast day rule set 300. In FIG. 3, the frame layout are illustrated as screen coordinates, but may also be realized as percent based geometries such as (50%, 25%) indicating a frame consuming half of the display width and one fourth of the display height. Typically, before the rules for a broadcast day rule set are determined, a site survey is performed. During the site survey numerous characteristics for the venue of the electronic display 10 are collected such as foot traffic schedules, demographic schedules, dwell time and captivity schedules, line of sight patterns, and venue geometry generally to determine favorable lighting and audibility locations. From the site survey data, a broadcast day rule set is defined. Thus the broadcast day rule set generally encapsulated the schedule of changes in audience dynamics.

Captivity and dwell time are parameters that reflect typical audience constraints and anticipated behaviors. The captivity parameter indicates the estimated ability of a potential viewer to easily leave the viewing area. The dwell time parameter, affected by captivity, estimates the amount of time a typical view is likely to remain in the viewing area. Captivity and dwell time parameter are very useful factors in determining an appropriate loop policy. For example, it is generally inappropriate to have multiple frames in a location with a low level of captivity, because, as a general rule, multiple frames dilute the impact of a particular advertising message.

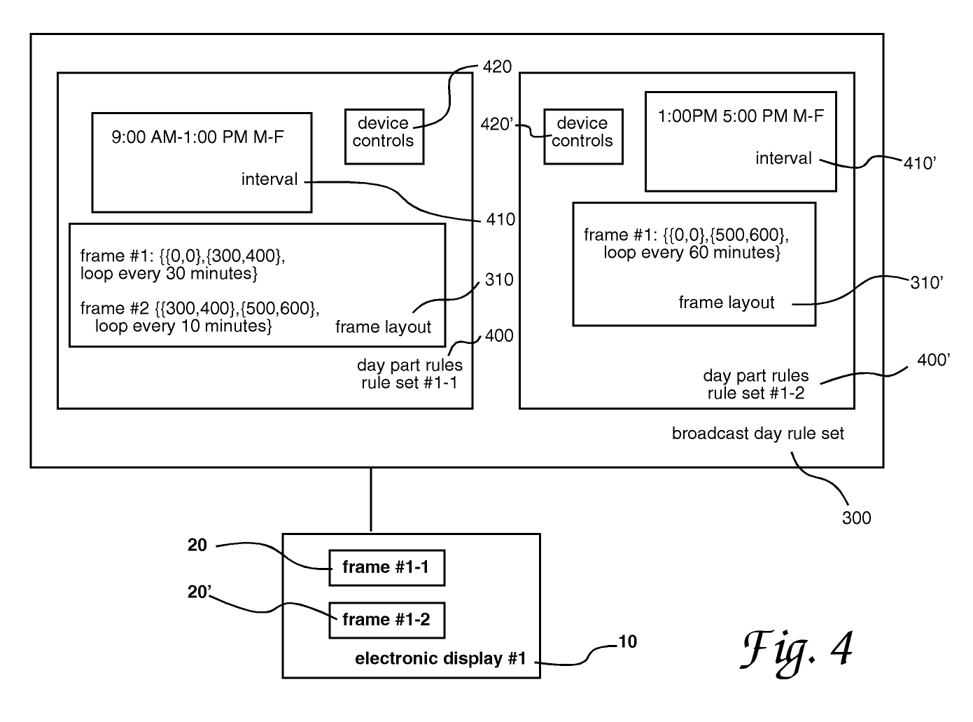

FIG. 4 illustrates the practice of the embodiment wherein the broadcast day rule set is subdivided into multiple day part rule sets, where each day part rule operates for the specified time, and each day part rule set has its own rules for its specified time period. Referring to FIG. 4, the broadcast day rule set 300 contains multiple day part rules sets 400. Each day part rule set 400 includes an interval 410 that identified the time period to which the day part rule set applies. Within each day part rule set 400 is optional device controls 420 that allow the associated electronic display 10 to be adjusted for the time period associated with the day part rules 400. Typical device controls include, but are not limited to, audio volume, brightness, gamma, and contrast controls.

The embodiment of FIG. 4 is particularly useful because each day part rule set 400 has its own frame layout 310. Thus, if there are times of a day where dwell time is higher, a frame layout 310 providing multiple frames might be appropriate, but the same electronic display 10 could be configured be limited to a single frame (full screen) during times of reduce dwell time.

The embodiment of FIG. 4 depicts a simple loop policy as part of the frame layout 310, but as a general rule, each day part rule set 400 can have its own loop policy for all frames or an individual loop policy for each frame. A loop policy is used to control the loop length which is the amount of time a display or frame displays content without repeating. Optimal loop policies generally correspond to dwell time so that individual viewers are not generally subjected to repeating content and, on average, typical viewers are likely to be exposed to the advertising message once.

One example of the use of an appropriate loop policy is a retailer having displays visible from checkout counters. Such an enterprise might have a five minute loop policy which corresponds to an average five minute average wait time for this hypothetical retailer. A second example might be a health services provider having an average dwell time of thirty minutes. A loop policy might be set for thirty minutes to accommodate an average waiting patient, or alternative, a loop policy of sixty minutes might be configured because the provider chooses to sell two slots in each loop schedule to play in alternating thirty minute slots.

In the embodiment, the broadcast day rule set can and typically does included one or more subsets of rules called “day parts”. A day part has a specified interval, and the rules for each day part are effective only for the time period associated with the specified interval of the day part. The broadcast day rule set may also include a blocking schedule which identifies times when the display in not operational regardless of the more general broadcast day rule set. In the embodiment, the blocking schedule of a broadcast day rule set overrides all days parts and ensures nothing is played during the blocked times. For example, if a retail store is closed on Christmas, the blocking schedule can effectively block Christmas Day, without any modifications to any of the other broadcast day rule set.

In the embodiment, day parts can have an associated weight. A day part having a greater weight will take precedence over a day part having a lesser weight for time intervals common to both day parts. For example, during special events one might want to override the default broadcast day rule set to account for audience dynamics of that special event. A mall, for example, typically would have a default broadcast day rule set for normal audience dynamics, but on a special occasion when a celebrity is performing at the mall, the audience dynamics and traffic patterns will change. A special “one day only” rule set can be created that identifies the date and time of the special occasion, having a frame layout and loop policy appropriate for the special occasion and also having a greater weight than the default rule set. This allows exceptional special events to be conveniently handled without disturbing the default rule sets.

This description is provided for the purposes of illustration, not limitation. As one skilled in the art will appreciate, there are a number of alternate embodiments of the present invention not shown, that are in the spirit of the invention. The invention is only limited by the claims as set forth below.

1. A system comprising:
one or more electronic displays, each electronic display capable of displaying at least one advertising message,
wherein each electronic display has at least one associated broadcast day rule set,
wherein each broadcast day rule set identifies allowable conditions for the electronic display to display an advertising message.

2. The system of claim 1, wherein said broadcast day rule set further includes a frame layout of said electronic display, wherein the frame layout describes how to partition said electronic display into at least one frame wherein each frame is capable of displaying said advertising message.

3. The system of claim 2, wherein said broadcast day rule set further includes, for each frame described in said frame layout, a loop policy, wherein the loop policy identifies conditions suitable for repeating display said advertising message on said frame.

4. The system of claim 3, wherein said broadcast day rule set further an interval specifier that identifies a time period having a start time and a duration, wherein said broadcast day rules are applicable only during said time interval identified by said interval specifier.

5. The system of claim 4, wherein each broadcast day rule set further includes a weighting parameter, wherein a first broadcast day rule set having a greater weight parameter will override a second broadcast day rule set having a lesser weighting parameter for any interval common to both said first and second broadcast day rule sets.

6. The system of claim 5, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

7. The system of claim 4, wherein each broadcast day parameter set further includes one or more blocking schedules, each blocking schedule further includes an associated start time and an associated duration, wherein intervals identified by said blocking schedule identify intervals wherein no content is displayed.

8. The system of claim 7, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

9. The system of claim 4, wherein the loop policy determines the frame layout, said broadcast day rule set has an associated dwell time parameter, and the loop policy favors a frame layout having fewer frames when the dwell time parameter is low.

10. The system of claim 9, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

11. The system of claim 4, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

12. The system of claim 3, wherein the loop policy determines the frame layout, said broadcast day rule set has an associated dwell time parameter, and the loop policy favors a frame layout having fewer frames when the dwell time parameter is low.

13. The system of claim 12, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

14. The system of claim 3, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

15. The system of claim 2, wherein said broadcast day rule set further an interval specifier that identifies a time period having a start time and a duration, wherein said broadcast day rules are applicable only during said time interval identified by said interval specifier.

16. The system of claim 15, wherein each broadcast day rule set further includes a weighting parameter, wherein a first broadcast day rule set having a greater weight parameter will override a second broadcast day rule set having a lesser weighting parameter for any interval common to both said first and second broadcast day rule sets.

17. The system of claim 16, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

18. The system of claim 15, wherein each broadcast day parameter set further includes one or more blocking schedules, each blocking schedule further includes an associated start time and an associated duration, wherein intervals identified by said blocking schedule identify intervals wherein no content is displayed.

19. The system of claim 18, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

20. The system of claim 15, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

21. The system of claim 2, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

22. The system of claim 1, wherein said broadcast day rule set further an interval specifier that identifies a time period having a start time and a duration, wherein said broadcast day rules are applicable only during said time interval identified by said interval specifier.

23. The system of claim 22, wherein each broadcast day rule set further includes a weighting parameter, wherein a first broadcast day rule set having a greater weight parameter will override a second broadcast day rule set having a lesser weighting parameter for any interval common to both said first and second broadcast day rule sets.

24. The system of claim 23, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

25. The system of claim 22, wherein each broadcast day parameter set further includes one or more blocking schedules, each blocking schedule further includes an associated start time and an associated duration, wherein intervals identified by said blocking schedule identify intervals wherein no content is displayed.

26. The system of claim 25, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

27. The system of claim 22, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

28. The system of claim 1, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

29. A method for efficiently distributing advertising content in a network comprising the steps of:
associating one or more electronic displays with the network, each electronic display capable of displaying at least one advertising message,
wherein each electronic display has at least one associated broadcast day rule set,
wherein each broadcast day rule set identifies allowable conditions for the electronic display to display an advertising message.

30. The method of claim 29, wherein said broadcast day rule set further includes a frame layout of said electronic display, wherein the frame layout describes how to partition said electronic display into at least one frame wherein each frame is capable of displaying said advertising message.

31. The method of claim 30, wherein said broadcast day rule set further includes, for each frame described in said frame layout, a loop policy, wherein the loop policy identifies conditions suitable for repeating display said advertising message on said frame.

32. The method of claim 31, wherein said broadcast day rule set further an interval specifier that identifies a time period having a start time and a duration, wherein said broadcast day rules are applicable only during said time interval identified by said interval specifier.

33. The method of claim 32, wherein each broadcast day rule set further includes a weighting parameter, wherein a first broadcast day rule set having a greater weight parameter will override a second broadcast day rule set having a lesser weighting parameter for any interval common to both said first and second broadcast day rule sets.

34. The method of claim 33, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

35. The method of claim 32, wherein each broadcast day parameter set further includes one or more blocking schedules, each blocking schedule further includes an associated start time and an associated duration, wherein intervals identified by said blocking schedule identify intervals wherein no content is displayed.

36. The method of claim 35, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

37. The method of claim 32, wherein the loop policy determines the frame layout, said broadcast day rule set has an associated dwell time parameter, and the loop policy favors a frame layout having fewer frames when the dwell time parameter is low.

38. The method of claim 37, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

39. The method of claim 32, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

40. The method of claim 31, wherein the loop policy determines the frame layout, said broadcast day rule set has an associated dwell time parameter, and the loop policy favors a frame layout having fewer frames when the dwell time parameter is low.

41. The method of claim 40, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

42. The method of claim 31, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

43. The method of claim 30, wherein said broadcast day rule set further an interval specifier that identifies a time period having a start time and a duration, wherein said broadcast day rules are applicable only during said time interval identified by said interval specifier.

44. The method of claim 43, wherein each broadcast day rule set further includes a weighting parameter, wherein a first broadcast day rule set having a greater weight parameter will override a second broadcast day rule set having a lesser weighting parameter for any interval common to both said first and second broadcast day rule sets.

45. The method of claim 44, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

46. The method of claim 43, wherein each broadcast day parameter set further includes one or more blocking schedules, each blocking schedule further includes an associated start time and an associated duration, wherein intervals identified by said blocking schedule identify intervals wherein no content is displayed.

47. The method of claim 46, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

48. The method of claim 43, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

49. The method of claim 30, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

50. The method of claim 29, wherein said broadcast day rule set further an interval specifier that identifies a time period having a start time and a duration, wherein said broadcast day rules are applicable only during said time interval identified by said interval specifier.

51. The method of claim 50, wherein each broadcast day rule set further includes a weighting parameter, wherein a first broadcast day rule set having a greater weight parameter will override a second broadcast day rule set having a lesser weighting parameter for any interval common to both said first and second broadcast day rule sets.

52. The method of claim 51, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

53. The method of claim 50, wherein each broadcast day parameter set further includes one or more blocking schedules, each blocking schedule further includes an associated start time and an associated duration, wherein intervals identified by said blocking schedule identify intervals wherein no content is displayed.

54. The method of claim 53, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

55. The method of claim 50, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.

56. The method of claim 29, wherein each broadcast day rule set further includes a device control for controlling the electronic display, wherein the device control further includes at least one of the following controls: brightness control, gamma control, contrast control, volume control, electronic display power switch for disabling said electronic display during periods of significant inactivity.
